(19) United States
(12) Patent Application Publication
(10) Pub. No.: US 2023/0415761 A1
(43) Pub. Date: Dec. 28, 2023

(54) SYSTEMS AND METHODS FOR VEHICLE MONITORING

(71) Applicant: Harman International Industries, Incorporated, Stamford, CT (US)

(72) Inventors: Bhargav Sandip Sura, Sterling Heights, MI (US); Sumit Dey, Ann Arbor, MI (US)

(21) Appl. No.: 18/252,868

(22) PCT Filed: Dec. 1, 2020
(86) PCT No.: PCT/US2020/062736

§ 371 Date: May 12, 2023

(51) Int. Cl. B60W 50/14; B60W 50/02

(52) U.S. Cl. CPC B60W 50/14; B60W 50/0205; B60W 2420/42; B60W 2420/40; B60W 2540/229; B60W 2552/05; B60W 2050/146

(57) ABSTRACT

Methods and systems are provided for an advanced driver-assistance system (ADAS). In one example, the ADAS includes an onboard diagnostics (OBD) adaptor configured to obtain information from vehicle sensors and an in-vehicle device communicatively linked to the OBD adaptor and configured to monitor driving conditions. The in-vehicle device is further configured to provide alerts to an operator based on a first set of data from the OBD adaptor and a second set of data from sensors of the in-vehicle device.

### FIELD

The disclosure relates to systems and methods for monitoring a vehicle and providing alerts to a vehicle operator.

### BACKGROUND

Use of advanced driver-assistance systems (ADAS) in modern vehicles has enabled improved vehicle handling and compliance to vehicular laws and regulation. By implementing systems such as sensors and cameras, human errors during vehicle operation may be decreased via generation of alerts, safeguards, and, in some instances, automated control of the vehicle by the ADAS. As an example, the ADAS may utilize data collected by an in-vehicle device, such as a dashboard camera, e.g., a dashcam, to detect nearby obstacles as viewed through a vehicle's windshield. The dashcam may include additional recording capabilities such as acceleration/deceleration g-force, speed, steering angle, GPS, etc., and may be configured with a communication technology, such as long-term evolution (LTE) connectivity.

An effectiveness of the ADAS may be dependent upon an accuracy of the ADAS's interpretation of and response to information provided by the sensors and cameras. For example, a low tolerance of the ADAS towards continually changing driving conditions may limit the ADAS's ability to diagnose situations demanding activation of driver alerts. Furthermore, the ADAS may rely on complex algorithms drawing heavily on computing power. As such, assistance provided by the ADAS may be based upon incomplete or inaccurate information, leading to driver frustration.

### SUMMARY

In order to improve the ability of the ADAS to accurately detect driving and vehicle conditions and comply to vehicular laws and regulations specific to a region, the vehicle's onboard diagnostics (e.g., OBD-II) may be used in conjunction with the sensors and cameras of the ADAS. The OBD-II may rapidly provide accurate data regarding vehicle status and conditions without further burdening a processing capability and memory resources of the in-vehicle computing system. The data may be used by the ADAS algorithms to guide a performance of the ADAS, allowing for more accurate adjustment of vehicle conditions and indication of issues potentially requiring operator notification.

Embodiments are disclosed for an ADAS of a vehicle, the ADAS including an onboard diagnostics (OBD) adaptor configured to obtain information from vehicle sensors and an in-vehicle device communicatively linked to the OBD adaptor and configured to monitor driving conditions and provide an alert to an operator. In one example, the OBD adaptor is an OBD dongle and the in-vehicle device is a dashcam. The dashcam is further adapted with a processor with computer readable instructions stored in non-transitory memory. When executed, the computer readable instructions cause the processor to receive a first set of data from the OBD adaptor, receive a second set of data from sensors of the in-vehicle device, and generate an output based on both the first set of data and the second set of data. The generated output includes one of activation or dampening of the alert, where the alert indicates a change in the monitored driving conditions.

In another embodiment, a method for the ADAS includes obtaining a first set of data from the sensors of the in-vehicle device, the first set of data collected based on the change in driving conditions, in response to a change in driving conditions detected at sensors of an in-vehicle device. The response also includes querying an onboard diagnostics (OBD) system of the vehicle by sending a request for vehicle information from the in-vehicle device to the OBD system, the vehicle information collected by the OBD system and extracted based on the first set of data to generate a second set of data. Furthermore, upon receiving the second set of data from the OBD system, an output is generated based on a combination of the first set of data and the second set of data, the output including presenting an alert to a driver at least at the in-vehicle device.

### BRIEF DESCRIPTION OF THE DRAWINGS

The disclosure may be better understood from reading the following description of non-limiting embodiments, with reference to the attached drawings, wherein below:

FIG. 1 shows a partial view of a vehicle cabin including an in-vehicle communication network and a dashboard camera (e.g., dashcam), in accordance with one or more embodiments of the present disclosure;

FIG. 2 shows a block diagram of a communication network including an advanced driver-assistance system (ADAS) and an onboard diagnostic system (OBD-II), in accordance with one or more embodiments of the present disclosure;

FIG. 3A shows an example of a vehicle adapted with an OBD-enhanced ADAS where the vehicle is preparing for a lane change, in accordance with one or more embodiments of the present disclosure;

FIG. 3B shows the vehicle of FIG. 3A changing lanes, in accordance with one or more embodiments of the present disclosure;

FIG. 4 shows an example of a routine for the lane departure warning system, in accordance with one or more embodiments of the present disclosure;

FIG. 5 shows an example of a routine for a distracted driver warning system, in accordance with one or more embodiments of the present disclosure;

FIG. 6 shows a vehicle adapted with an OBD-enhanced ADAS where the vehicle is driving in a high occupancy vehicle (HOV) lane, in accordance with one or more embodiments of the present disclosure;

FIG. 7 shows an example of a routine for an HOV warning system, in accordance with one or more embodiments of the present disclosure;

FIG. 8 shows an example of a first routine for a headlamp warning system, in accordance with one or more embodiments of the present disclosure;

FIG. 9 shows an example of a second routine for the headlamp warning system, in accordance with one or more embodiments of the present disclosure; and

FIG. 10 shows an example of a routine for a parking warning system, in accordance with one or more embodiments of the present disclosure.

### DETAILED DESCRIPTION

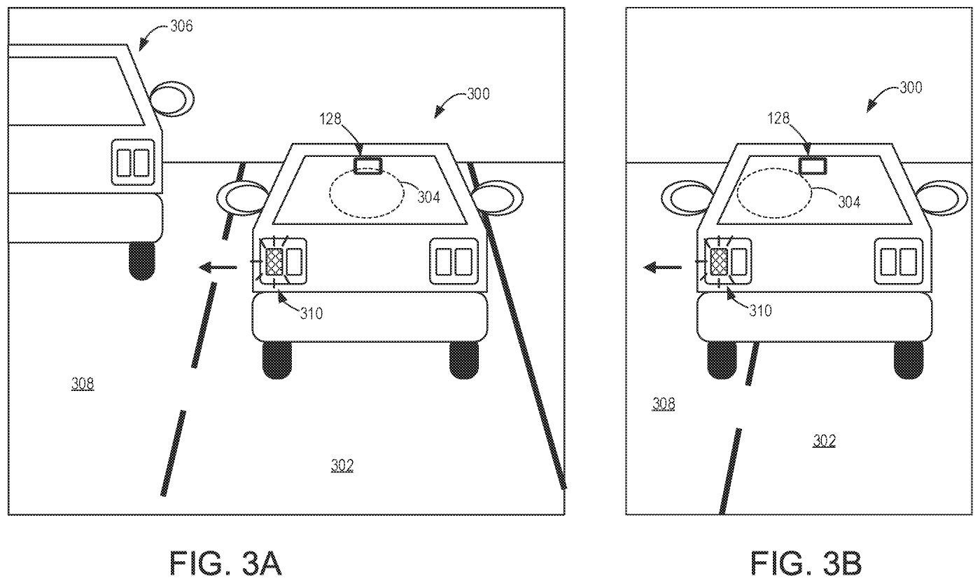

The following description relates to systems and methods for an advanced driver-assistance system (ADAS) of a vehicle. In one example, alerts generated by the ADAS in response to signals provided by sensors of an ADAS device, such as a dashboard camera or dashcam, may represent a current driving condition more accurately by enhancing the signals with data obtained from an onboard diagnostics (OBD) system of the vehicle. The OBD system may provide information regarding a current state of the vehicle based on vehicle sensors which may be used to modify the data provided by the dashcam. The modification of the data may allow the ADAS to provide more useful notifications to a driver and by refining the data to take in account additional conditions detected by the vehicle sensors. Use of the information from the OBD system may expand monitoring and assessment capabilities of the ADAS, thereby reducing an effect of human error on vehicle operation. Examples of ADAS alerts which may be enhanced by OBD data are described further below with reference to FIGS. 3A-10.

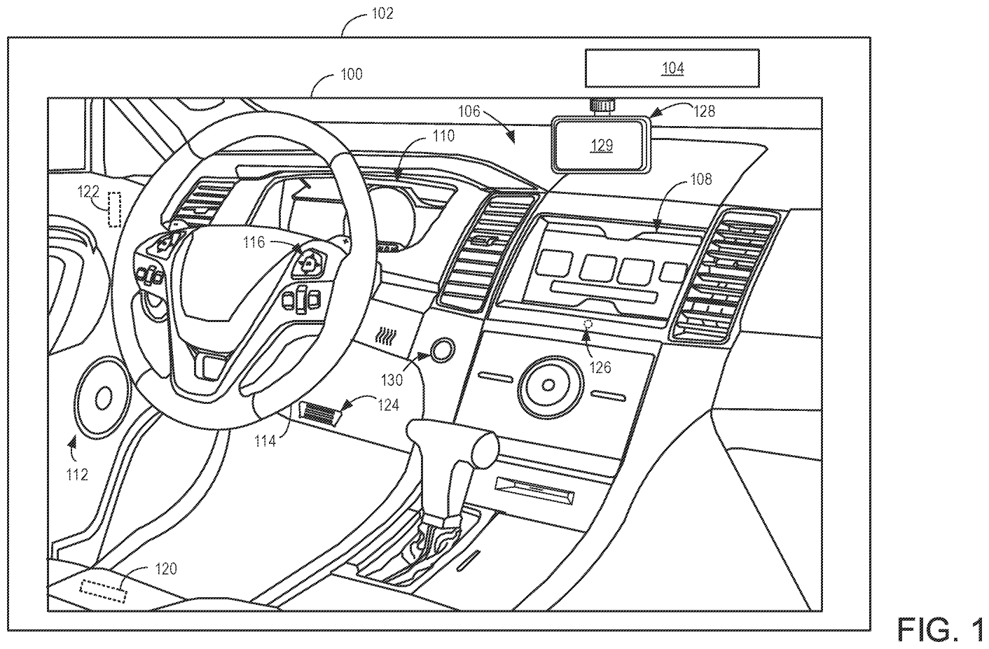

FIG. 1 shows an example partial view of an interior of a cabin 100 of a vehicle 102, in which a driver and/or one or more passengers may be seated. Vehicle 102 of FIG. 1 may be a motor vehicle including drive wheels (not shown) and an internal combustion engine 104. Internal combustion engine 104 may include one or more combustion chambers which may receive intake air via an intake passage and exhaust combustion gases via an exhaust passage. Vehicle 102 may be a road automobile, among other types of vehicles. In some examples, vehicle 102 may include a hybrid propulsion system including an energy conversion device operable to absorb energy from vehicle motion and/or the engine and convert the absorbed energy to an energy form suitable for storage by an energy storage device. In yet other examples, vehicle 102 may be a fully electric vehicle, incorporating fuel cells, solar energy capturing elements, and/or other energy storage systems for powering the vehicle.

As shown, an instrument panel 106 may include various displays and controls accessible to a driver of vehicle 102, such as a dashboard user interface 108, such as a touch screen, of an in-vehicle interface system (e.g., an infotainment system), an audio system control panel, and an instrument cluster 110. While the example system shown in FIG. 1 includes audio and visual system controls that may be performed via the user interface 108 of an in-vehicle interface system without a separate control panel, in other embodiments, the vehicle 102 may include an audio and/or visual system control panel. The audio system controls may include features for controlling one or more aspects of audio output via speakers 112 of a vehicle speaker system. The visual system controls may include features for adjusting images displayed at the user interface 108.

Instrument cluster 110 may include various gauges such as a fuel gauge, tachometer, speedometer, and odometer, as well as indicators and warning lights. A steering wheel 114 may project from the instrument panel 106 below instrument cluster 110. Steering wheel 114 may include controls 116 to control the in-vehicle interface system and may further include other controls, such as turn indicators, a headlamp switch, a windshield wiper switch, etc., coupled to a steering column of the steering wheel 114.

In addition to the components depicted in FIG. 1, it will be appreciated that instrument panel 106 may also include components such as door and window controls, a glove compartment, and/or any other suitable elements.

The cabin 100 may include one or more sensors for monitoring the vehicle, the user, and/or the environment. For example, the cabin 100 may include one or more seat-mounted pressure sensors 120 configured to measure the pressure applied to the seat to determine the presence of a user. The cabin 100 may include one or more door sensors 122 configured to monitor door activity, such as the opening and/or closing of the door, the locking of the door, the operation of a window of the door, and/or any other suitable door activity event. A microphone 126 may be included to receive user input in the form of voice commands, to enable a user to conduct telephone calls, and/or to measure ambient noise in the cabin 100. It is to be understood that the placement of the sensors illustrated in FIG. 1 is exemplary, and one or more additional or alternative sensors may be positioned in an engine compartment, on an external surface of the vehicle 102, and/or in other suitable locations for providing information regarding the operation of the vehicle, ambient conditions of the vehicle, a user of the vehicle, and so on.

The sensors of the cabin 100 may be communicatively coupled to a vehicle controller which may include a microprocessor unit (MCU), an electronic storage medium for executable programs/instructions, random access memory, keep alive memory, a power control module, a body control module, a network access device (NAD) and a data bus. In one example, the data bus may be a Controller Area Network (CAN) bus configured to facilitate data communication within the vehicle 102.

Information collected at the sensors and stored in the controller's memory may be accessed through an onboard diagnostics (OBD) port 124. More specifically, as shown in FIG. 1, the OBD port 124 may be an OBD-II port 124. By inserting an aftermarket device, e.g., plug-in telematics such as a dongle, into the OBD-II port 124, data regarding selected vehicle parameters and diagnostic troubles codes (DTCs) may be obtained. It will be appreciated that a location of the OBD-II port 124 shown in FIG. 1 is a non-limiting example of a positioning of the OBD-II port 124. In other examples, the OBD-II port may be located elsewhere in the cabin 100.

The cabin 100 may also include an additional aftermarket, in-vehicle device to monitor driving conditions and provide alerts and notification to the driver through an advanced driver-assistance system (ADAS) implemented at the device. In one example, the in-vehicle device may be a dashboard camera or dashcam 128, which may be stored in the vehicle 102 before, during and/or after traveling. The dashcam 128 may be attachable, for example, to a windshield of the vehicle 102 and include a wide angle front camera configured to record a view through at least the windshield, and in some examples, also through other windows of the vehicle 102. As another example, the dashcam 128 may instead be mounted on the dashboard of the vehicle 102. A cabin-facing side of the dashcam 128 may be configured with a user interface 129. A view captured by a camera lens of the dashcam 128 may be displayed at the user interface 129 in real-time as well as alerts and notifications. In some examples, the user interface 129 may be a touch-screen adapted to receive input at the user interface 129 from the user.

In some instances, the dashcam 128 may also include an integrated camera with a cabin monitoring system (CMS), the CMS camera configured to record a 360-degree view within the cabin 100. However, in other examples, the CMS camera may be a stand-alone camera that is not integrated into the dashcam 128. In one example, the dashcam 128 may further include a rear camera mounted in a rear window of the vehicle 102 or elsewhere in a rear region of the vehicle. The rear camera may provide images and video recordings of a view behind the vehicle 102.

The dashcam 128 may also have a microcontroller unit (MCU) which stores executable instructions for operating the sensors of the dashcam 128 and stores data collected from the sensors in non-transitory memory. Additionally, the dashcam 128 may be configured with various sensors to monitor various vehicle operating parameters. For example, the dashcam 128 may include sensors to measure vehicle acceleration/deceleration, vehicle speed, steering angle, GPS data, etc. The dashcam 128 may be powered via a power cable drawing electrical power from a power outlet in the cabin, such as from a cigarette lighter socket 130. Alternatively, the dashcam 128 may be wired directly into an electrical system of the vehicle 102 or may be powered by a battery.

The dashcam 128 may be configured with wireless communication, such as Wi-Fi, Bluetooth, or long-term evolution (LTE) connectivity, allowing the dashcam 128 to communicate with the CAN bus of the vehicle 102. Furthermore, in some examples, the dashcam 128 may be configured as a device for an Advanced Driver Assistant System (ADAS), enabling monitoring of vehicle operation and driving conditions to provide alerts and notifications to an operator. For example, the ADAS may include a Forward Collision Warning System to warn the operator when the vehicle 102 is approaching another vehicle at high speed, a Lane Departure Warning System to notify the operator when the car is veering into an adjacent lane, and various other types of monitoring systems.

While the use of ADAS technology in a dashcam may reduce a likelihood of human error during vehicle operation, an accuracy of the ADAS may be constrained by an ability of the dashcam to adapt to variability in environmental and operating parameters. The dashcam may impose a heavy computing demand due to use of complex algorithms, which may, in some examples, limit the dashcam's processing capabilities to a single set of data in real-time. As a result, evaluation of whether driver notification is warranted based on vehicle operations and/or environmental conditions may be inaccurate and/or inconsistent.

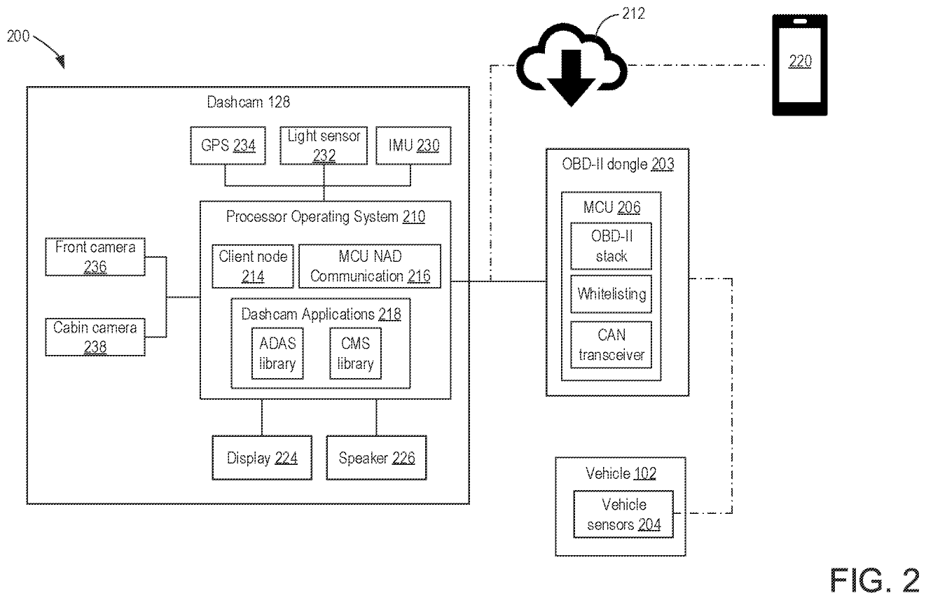

To at least partially address the issues described above, the inventors herein have recognized that by combining information collected by vehicle sensors through an OBD-II port of a vehicle with data obtained by the ADAS, driving conditions and vehicle operations may be more accurately assessed, thereby allowing the ADAS to provide more effective and reliable driving assistance. For example, an aftermarket plug-in telematics device, such as a OBD adapter or dongle, may be inserted into the OBD-II port. The dongle may be adapted with a wireless communication format, such as Bluetooth, Wi-Fi, or LTE connectivity, allowing information provided by the vehicle OBD to be relayed to a receiving device by way of a vehicle controller CAN bus and the dongle. As such, the dongle may communicate with the ADAS dashcam and the ADAS may use the sensor data provided by the vehicle OBD through the dongle to increase an accuracy and sensitivity of the ADAS. A communication network including the vehicle controller, dongle, and dashcam, is described further below, with reference to FIG. 2.

By implementing an aftermarket, OBD-enhanced ADAS in the vehicle, the ability of the ADAS to accurately detect and diagnose conditions demanding operator notification is increased without further burdening a computing capacity of the ADAS. Such conditions include recognizing changes in driver head positioning, appearance of road signs, environmental changes such as ambient light, tilting of the vehicle when parked, etc. The ADAS may be configured to extract relevant information from the OBD data for a specific application and command display of an alert accordingly at a user interface of the dashcam. In this way, the OBD data provides information obtained directly from the vehicle sensors to guide the ADAS algorithms to generate an output that accurately assesses the vehicle and/or driving conditions. The output may be an alert or notification to warn the driver of the changes in the vehicle/driving conditions. An increased effectiveness of the ADAS when enhanced by OBD data is illustrated in the examples described below, with reference to FIGS. 3A-10.

A block diagram of a vehicle communication system 200 is shown in FIG. 2. The communication system 200 may connect elements of the vehicle 102, e.g., the vehicle 102 of FIG. 1, an OBD-II system and an ADAS. The OBD-II system includes an OBD-II dongle (hereafter, dongle) 203 which may receive information regarding vehicle sensors 204, such as sensors detecting statuses of the vehicle headlights, ignition, turn indicators, etc. The information may be transmitted through a CAN bus of the vehicle 102 and received at a CAN transceiver of the dongle 203. In one example, the dongle may communicate with the vehicle sensors 204 through a proportional-integral-derivative (PID) communication mode. The dongle 203 may be plugged into a port in the vehicle 102 to allow the dongle 203 to be communicatively coupled to the dashcam 128 of the ADAS (e.g., the dashcam 128 of FIG. 1). The sensor information may be processed at an OBD-II stack of the MCU 206 and streamlined to isolate one or more sets of data to be utilized at the dashcam 128.

For example, the streamlining of the data includes extracting data relevant to a change detected by sensors of the dashcam 128. As an example, the change may be a detection, via a front camera sensor 236 of the dashcam 128, of a road sign indicating that a lane that the vehicle 102 is currently travelling in has become a high occupancy vehicle (HOV) lane. The OBD data may be whitelisted at the MCU 206 to allow only data relevant to evaluating a validity of the vehicle 102, with respect to travelling in the HOV lane, to be relayed to the ADAS processor operating system (OS) 210. The whitelisted data may include vehicle information, e.g., a make, model and year (MMY) based on a vehicle identification number (VIN) of the vehicle and a propulsion type of the vehicle (e.g., electric, hybrid electric, ICE) based on the MMY. The whitelisted OBD data is received by the ADAS at the processor OS 210 and used to modify the output of the ADAS which may include a visual and/or audio alert, as described further below.

In one example, the dongle 203 may be coupled to the processor operating system (OS) 210 of the dashcam 128 by a wired connection including a universal asynchronous receiver-transmitter (UART). The whitelisted data may be processed at one or more modules of the processor OS 210. The modules may include, for example, a client node module 214 for information transmission to and from a cloud server node 212, a MCU network access device (NAD) communication module 216, and a dashcam applications module 218.

Flow of data between the dongle 203 and the dashcam 128 occurs via a client-server communication and may be sent to the cloud server node 212 via a wireless link, such as LTE connectivity, and stored at the cloud server node 212. For example, the client node module 214 of the dashcam 128 may receive information from sensors of the dashcam 128 and OBD data from the dongle 203 and sends the information through a backend. The client node module 214 may include an associated server URL to relay the information accordingly. More specifically, the cloud server node 212 may receive data from the client node module 214 which may relay data that has been processed by the other modules of the processor OS 210.

The stored data may be accessed, also via LTE connectivity, for example, by a mobile device 220. The mobile device may be separate from the vehicle 102 and may be used inside or outside (e.g., external to) of the vehicle 102. The mobile device 220 may be configured to receive notifications and alerts from the ADAS regarding driving conditions, vehicle status, etc., via an application installed on the mobile device 220. The application allows the mobile device to communicate with the cloud server node 212 and access information stored thereat. In some examples, instructions and/or notifications may be input at the mobile device 220 by a user and delivered to the processor OS 210 for execution. The cloud server node 212 may also be configured to store various databases accessible by the ADAS to further modify the output of the ADAS.

The MCU NAD communication module 216 of the dashcam processor OS 210 may receive the whitelisted data from the dongle 203 and send the data to the dashcam applications module 218 to be used to modulate data transmitted to the dashcam applications module 218 from dashcam sensors. The dashcam sensors may include, for example, an inertial measurement unit (IMU) 230, a light (e.g., ambient light) sensor 232, a GPS 234, the front camera sensor 236, and a cabin camera sensor 238. It will be appreciated, however, that the sensors listed in FIG. 2 are illustrative and the dashcam may include numerous other sensors not described herein.

Dashcam sensor signals relayed to the dashcam applications module 218 may be parsed to data libraries, such as an ADAS library and a cabin monitoring system (CMS) library, each library configured to store data from specific sensors. The dashcam applications 218 may process and interpret the data and send instructions to output devices of the dashcam 128 accordingly. For example, the dashcam applications 218 may command a visual alert or notification to be presented at a display 224 of the dashcam 128.

The display 224 may display images and/or messages to provide visual feedback related to information provided by the dashcam sensors and the dongle 203. For example, the display 224 may show a view detected by the front camera sensor in real-time. The view may be overridden, in some examples, by alerts/notifications demanding immediate driver awareness and response. In one example, the display 224 may include a touch screen configured to receive input from a user based on contact with the touch screen. Furthermore, the dashcam output devices may include a speaker 226. The speaker 226 may be configured to provide audio alerts and notifications when commanded by the dashcam applications 218 and may be activated as an alternative or in addition to the visual alerts/notifications. In some instances, the speaker 226 may be used to send audio alerts when alerting the driver is demanded for specific events. For example, the speaker 226 may send audio alerts for Forward Collision Warning (FCW), HOV lane violation, Lights on/off alerts, etc., as described further below.

As shown in FIG. 2, an OBD-II dongle may be communicatively coupled to an ADAS dashcam to modulate the ADAS capabilities based on OBD data. The OBD data provides accurate information regarding vehicle conditions which may be used to adjust or correct signals collected by the dashcam sensors. In this way, an accuracy and response of the ADAS to vehicle operation may be increased without increasing a computing demand and a complexity of the ADAS. Examples of ADAS applications which may benefit from enhancement by OBD data are described below.

In a first example of an OBD-enhanced ADAS application in a vehicle, the OBD data may be used to supplement a Lane Departure Warning (LDW) system of the ADAS dashcam. The LDW system may include using a region of interest (ROI) based on a central focal region of the dashcam's forward-facing camera to determine if the vehicle is drifting into an adjacent lane during travel. Upon detecting a lane departure, the dashcam may provide an alert to the user. However, in a conventional system, the alert is activated regardless of an intention of the user. For example, the user may desire a lane change and choose to navigate the vehicle into the adjacent lane but such a selection is not relayed to the dashcam, thereby causing irritation to the user. Furthermore, the dashcam may be unable to assess additional aspects which may be relevant to the user when deciding to perform a lane change, such as evaluating a proximity of a vehicle in front in the adjacent lane.

When supplemented by OBD data, the LDW system may activate the alert only when the lane change is not indicated to be intentional. Furthermore, the LDW system may be configured to estimate how close a neighboring vehicle in the adjacent lane may be to the vehicle adapted with the OBD-enhanced ADAS. For example, as shown in FIG. 3A, a first vehicle 300 (which may be an embodiment of the vehicle 102 of FIGS. 1 and 2), may be navigating along a first lane 302 of a multi-lane road. A front camera sensor of the dashcam 128 (e.g., the dashcam 128 installed in the vehicle 102 of FIGS. 1 and 2) may have a ROI 304 in a field of view of the front camera sensor that is centered immediately ahead of the front camera sensor. A second vehicle 306 may be travelling in a second, adjacent lane 308 ahead of the first vehicle 300.

A driver of the first vehicle 300 may wish to move to the second lane 308. The driver may activate a left turn signal 310 of the first vehicle 300, e.g., by manipulating a turn indicator, and begin to shift into the second lane 308. As the first vehicle 300 veers into the second lane 308, the front camera sensor of the dashcam 128 detects the lane change. For example, the dashcam processor OS may include algorithms for recognizing lane markings of the road. By comparing a position of the lane markings within the ROI 304, the ADAS may identify a shift in alignment of the first vehicle 300 relative to the lane markings. The dashcam 128 may query the OBD data provided by a dongle, e.g., the dongle 203 of FIG. 2, and determine that the left turn signal 310 is on, e.g., active. The LDW alert is therefore dampened, e.g., display of a visual and/or audio alert is reduced or suppressed at the dashcam 128. Furthermore, as the lane change is detected and the ADAS confirms that the left turn signal 310 is on to indicate a shift to the left, the ROI 304 of the dashcam 128 may shift to the left of the field of view, as shown in FIG. 3B.

By shifting the ROI 304 to the left, the second vehicle 306, as shown in FIG. 3A, may be included in the ROI 304. The dashcam 128 may estimate a distance between the second vehicle 306 and the first vehicle 300 and activate a visual and/or audio alert if the second vehicle 306 is deemed too close to the first vehicle 300 for the lane change. Additionally, an alert warning the driver that the vehicle is drifting out of lane is only activated if the dashcam detects the lane change without actuation of a turn indicator. As such, if the ADAS confirms that the turn indicator is on via the OBD data, the LDW alert is dampened, e.g., display of the alert is reduced or muted/suppressed. The ADAS may thereby provide more useful alerts and notifications with a reduced likelihood that the driver may ignore the warning.

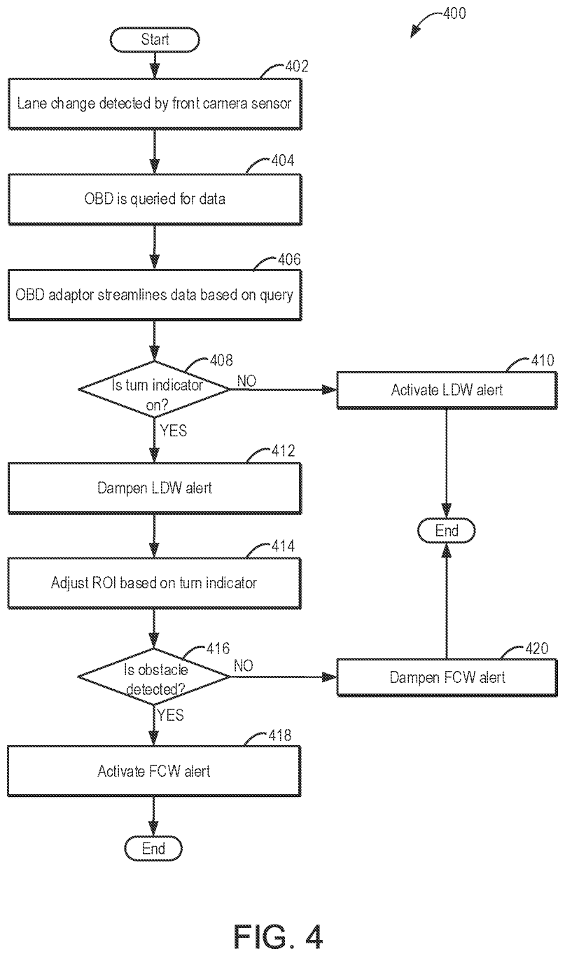

An example of a routine 400 for enhancing a LDW system of a dashcam with OBD data is shown in FIG. 4. Routine 400 may be implemented in a vehicle such as vehicle 102 of FIGS. 1-2 and vehicle 300 of FIGS. 3A-3B, the vehicle including a dashcam such as the dashcam 128 of FIGS. 1-3B. The vehicle is operating, e.g., in a travel mode propelled by a prime mover such as an engine or a battery. The vehicle further includes an OBD adaptor or dongle, such as the dongle 203 of FIG. 2. A processor OS of the dashcam, such as the processor OS 210 of FIG. 2, receives signals from the OBD system and from the various sensors of the dashcam and provides alerts and notifications at the dashcam based on the received signals and instructions stored on a memory of the processor.

At 402, the routine includes detecting that a lane change is occurring as the vehicle is being driven. The lane change may be detected by a front camera sensor of the dashcam. For example, the front camera may recognize lane markings in a ROI of its field of view, as described above, and detect that the vehicle is altering its position relative to the lane markings. Upon detecting the lane change, the routine continues to 404 to query the OBD system through a PID connection between the dashcam and the dongle. The query may include the ADAS requesting information relevant to the detected lane change from the OBD system.

For example, by requesting relevant information to the detected lane change, an MCU of the dongle may be prompted to streamline the OBD data at 406, e.g., by whitelisting, and extract data determined to be useful for modifying an output of the ADAS with respect to a LDW alert. In one example, the useful data may include a status of a turn indicator of the vehicle. The turn indicator may be in an on (e.g., left turn signal activation or right turn signal activation) or off mode.

At 408, the routine includes determining if the turn indicator is on at 404. The turn indicator may be a driver-activated switch connected to turn signals of the vehicle. The status of the turn indicator, e.g., an electric circuit of the switch, may be monitored by the OBD-II system and continuous data regarding the status of the turn indicator may be transmitted to the dashcam processor OS to generate an ADAS output.

If the turn indicator is not on, the routine proceeds to 410 to present a first output outcome of ADAS by activating the LDW alert. The LDW alert may include displaying a notification at a display screen of the dashcam. Additionally or alternatively, an audio notification may be announced through a speaker of the dashcam. Furthermore, in some examples, the alert may be relayed to a wirelessly connected mobile device via a cloud server and similarly displayed/announced at the mobile device. In yet other examples, the alert may also be displayed at a dashboard user interface of the vehicle. The routine ends.

If the turn indicator is on, the routine continues to 412 to present a second output outcome of the ADAS by dampening, suppressing and/or muting the LDW alert such that the alert is not displayed or announced. At 414, the routine includes adjusting the ROI of the front camera sensor of the dashcam according to the activated turn indicator. For example, if the left turn indicator is activated, the ROI shifts to the left in the front camera sensor's field of view and if the right turn indicator is activated, the ROI shifts to the right.

At 416, the routine includes determining if an obstacle (e.g., another vehicle) is detected in the adjusted ROI. The dashcam may include algorithms for recognizing a change in the ROI such when an obstacle appears. The adjusted ROI allows identification of the obstacle in the new lane as well as estimation of a distance between the vehicle and the obstacle. If the obstacle is detected, a FCW is activated at 418 and displayed/announced at the dashcam and, in some examples, at the mobile device and/or a dashboard user interface of the vehicle. If the obstacle is not detected, the FCW alert is dampened at 420, which may include suppressing/muting the alert, and the routine ends.

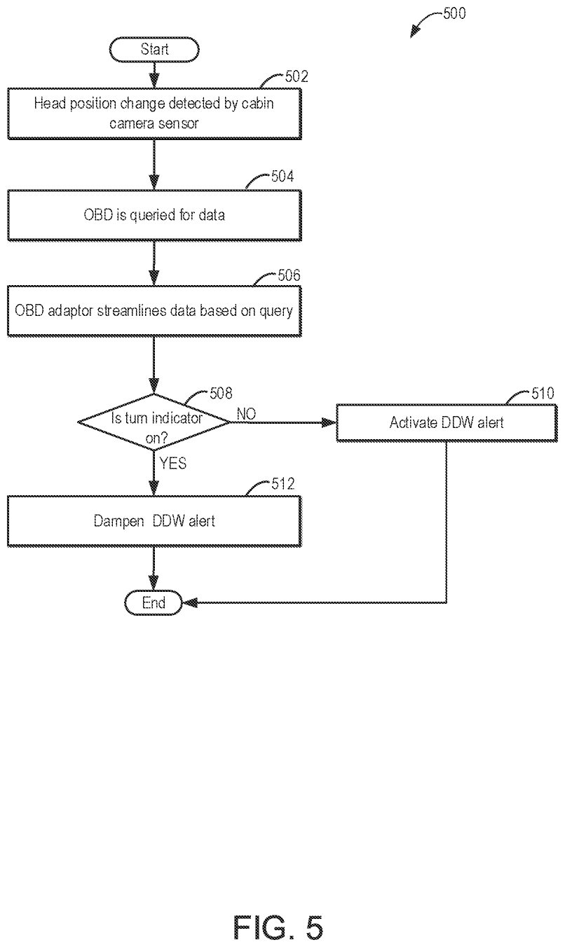

In another example, the OBD data regarding turn indicator status may be used to determine if the driver is distracted while driving. As shown in FIG. 5, a routine 500 for enhancing a distracted driver warning (DDW) system of the ADAS may be implemented in the vehicle as described above with reference to routine 400 of FIG. 4. Routine 500 may be conducted also while the vehicle is in transit.

At 502, the routine includes detecting a change in a head position of the driver. For example, a cabin camera sensor of the dashcam may face a cabin of the vehicle and monitor movement within the cabin. Thus the dashcam may include algorithms allowing the ADAS to recognize when the driver's head turns such that the driver is not looking forward. Upon detecting the change in the driver's head position, the ADAS may query the OBD system at 504 for relevant data from the vehicle sensors.

As an example, the query may include a request for data usable in combination with the detected change in the driver's head position which may include data regarding the status of the turn indicator. In response to the request, the MCU of the dongle may streamline the data at 506, e.g., by whitelisting, to extract information obtained through monitoring of the turn indicator electrical circuit and relay the extracted information to the ADAS.

The routine includes confirming if the turn indicator (e.g., right or left turn indicator) is on at 508 based on the data provided by the OBD system. If the turn indicator is not on, the routine proceeds to 510 to provide a first output outcome of the ADAS by activating a DDW alert at the display/speaker of the dashcam and, in some examples, at the mobile device and/or a dashboard user interface of the vehicle. If the turn indicator is on, the routine continues to 512 to provide a second output outcome of the ADAS by dampening the DDW alert. The routine ends.

By using the OBD data in combination with ADAS DDW system, the DDW alert is not activated when the driver head is intentionally turned. Superfluous warnings to the driver are thereby circumvented in instances where the driver is, for example, performing a blind spot check upon changing lanes. In some examples, routine 400 may be used in conjunction with routine 500 to further refine the ADAS.

In a second example of an OBD-enhanced ADAS application in a vehicle, the OBD data may be used to supplement dashcam information to assess a high-occupancy vehicle (HOV) validity of the vehicle. An ADAS dashcam, such as the dashcam 128 of FIGS. 1-2 and 3A-3B, may include a forward camera sensor adapted with a signage detection capability, a cabin camera sensor configured with algorithms for a cabin-monitoring system (CMS) enabling face detection, and a GPS. Information obtained from the dashcam sensors and systems may be used in conjunction with OBD data, including monitoring of seat weight, seat belt latching, and vehicle information such as the MMY based on a VIN of the vehicle as well as a propulsion system of the vehicle based on the MMY. The combined data sets may allow the dashcam to recognize that the vehicle is entering an HOV lane and assess whether the vehicle complies with HOV rules of a geographic region.

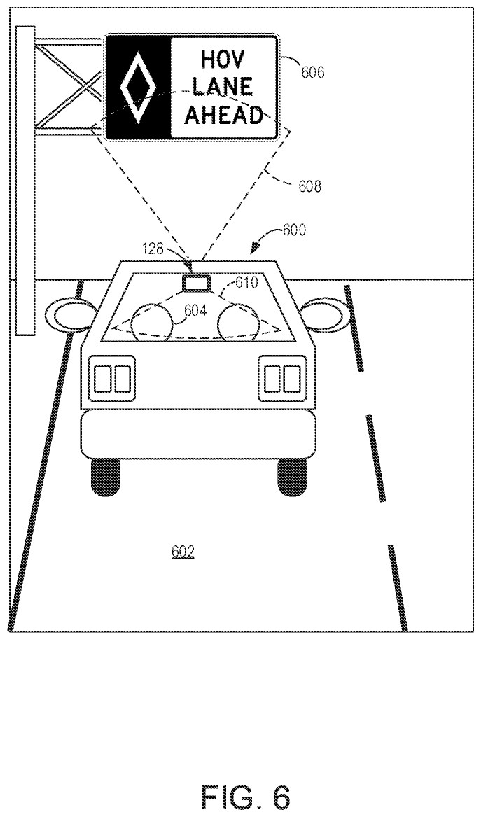

For example, as shown in FIG. 6, a vehicle 600, which may an embodiment of the vehicle 102 of FIGS. 1 and 2, may be navigating along a lane 602, such as a lane of a highway. The vehicle 600 includes the dashcam 128 and one or more passengers 604. As the vehicle 600 travels, a sign 606 may enter a field of view 608 of the front camera sensor of the dashcam 128. The sign 606 may provide information about a classification of the lane, e.g., the lane 602 is or may soon become an HOV lane.

The signage detection capability of the dashcam allows the ADAS to recognize the HOV classification of the lane 602 which initiates querying of the OBD data, e.g., via a PID mechanism, to obtain vehicle information, e.g., the MMY, to determine if the vehicle 600 is an electric, hybrid-electric, or internal combustion engine (ICE) vehicle. The dashcam may utilize GPS data to identify a location of the vehicle 300 and access regional rules regarding usage of HOV lanes, e.g., if electric/hybrid-electric vehicles are permitted and a minimum vehicle occupancy for compliant usage.

The dashcam may also utilize one or more of the seat weight detection, seat belt latching detection, and face detection to determine a number of occupants in the vehicle 600. For example, a cabin camera sensor of the dashcam 128 may count a number of passenger faces observed in a field of view 610 of the cabin camera sensor and the ADAS may compare the number of faces to occupied seats (e.g., based on weight) and latched seatbelts, as indicated by the OBD data. The ADAS may use the information provided by the sensors/systems of the dashcam and the OBD data to validate vehicle travel in the HOV lane 602 and generate an output that may be presented to the driver as an alert or notification. For example, if the ADAS determines that the vehicle 600 does not comply with HOV rules based on vehicle occupancy and regional rules, the alert is displayed and/or announced at the dashcam. In some examples, the alert may also be activated at a mobile device linked wirelessly to the dashcam. Additionally, the alert may be displayed at a dashboard user interface of the vehicle. As an alternative output outcome, the alert may be dampened, which may include suppressing and/or muting the alert, e.g., not displayed or announced.

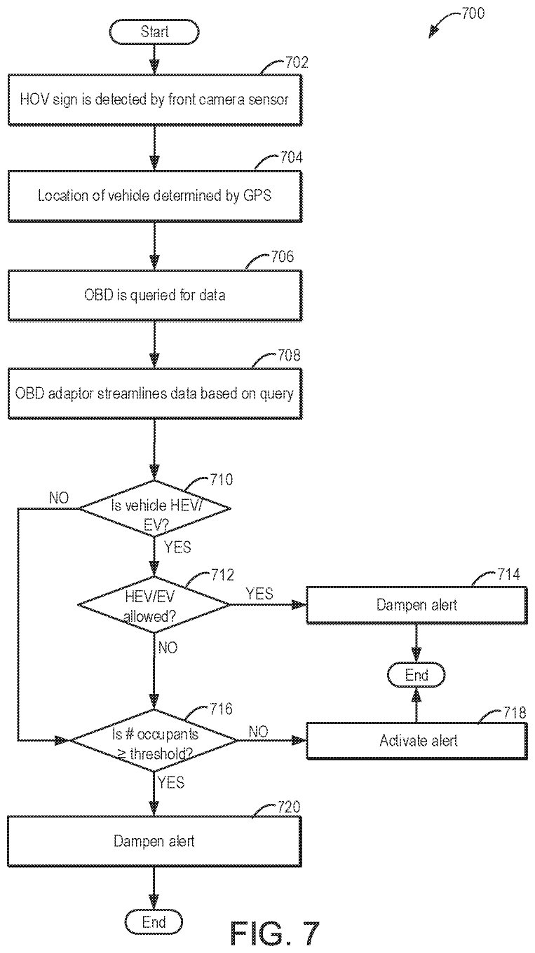

An example of a routine 700 for enhancing an HOV validating system of a dashcam with OBD data is shown in FIG. 7. Routine 700 may be implemented in a vehicle such as vehicle 102 of FIGS. 1-2 and vehicle 600 of FIG. 6, the vehicle including a dashcam such as the dashcam 128 of FIGS. 1-3B and 6. The vehicle is operating, e.g., in a travel mode propelled by a prime mover such as an engine or a battery. The vehicle further includes an OBD adaptor or dongle, such as the dongle 203 of FIG. 2. A processor OS of the dashcam, such as the processor OS 210 of FIG. 2 receives signals from the OBD system and from the various sensors of the dashcam and provides alerts and notifications at the dashcam based on the received signals and instructions stored on a memory of the processor.

At 702, the routine includes detecting a sign indicating that a lane that the vehicle is travelling in is/will become an HOV lane. For example, the sign may enter a field of view of a front camera sensor of the dashcam, as described above. A sign detection capability of the dashcam may recognize that the sign indicates an HOV classification of the lane. Detection of the sign may prompt the ADAS to identify a location of the vehicle at 704, which may be provided by a GPS of the dashcam. At 706, the routine includes querying the OBD data through a PID connection between the dashcam and the dongle.

Querying the OBD data may include sending a request for data relevant to evaluating a validity of the vehicle regarding use of the HOV lane, e.g., if the vehicle complies with HOV lane rules. Furthermore, the requested data may also include information regarding regional HOV lane rules specific to the location of the vehicle. Upon receiving the request, the MCU of the dongle streamlines the OBD data at 708 by, for example, whitelisting the data to transmit only relevant data. The relevant data may include the MMY based on the vehicle VIN and identification of the vehicle's propulsion system based on the MMY. The ADAS may also refer to regional HOV rules extracted from a database which may be stored on a server, such as the cloud server node 212 of FIG. 2.

The routine includes confirming if the vehicle is an electric vehicle (EV) or a hybrid-electric vehicle (HEV) at 710 based on the OBD data. If the vehicle is not an EV/HEV, the routine proceeds to 716 to verify if a number of vehicle occupants reaches a threshold quantity, as described further below.

If the vehicle is confirmed to be an EV/HEV, the routine continues to 712 to determine if the EV/HEV is allowed in the HOV lane. The ADAS may utilize the regional HOV lane rules and regulations obtained via the combination of GPS data and the retrieved information from the database. By referring to the regional HOV regulations, the ADAS may verify whether an exception to occupancy rules applies to EVs/HEVs, e.g., EVs/HEVs are allowed in the HOV lane regardless of occupant number. If the EV/HEV is permitted to use the HOV lane, the routine continues to 714 to output a first outcome of the ADAS by dampening an HOV alert. Dampening the alert may include suppressing and/or muting the HOV alert (e.g., not displaying and/or not announcing the HOV alert at the dashcam) at a mobile device wirelessly connected to the dashcam, or at a dashboard user interface of the vehicle.

If an exception to the HOV rules is not verified for the EV/HEV, the routine proceeds to 716 to determine if the number of vehicle occupants meets a threshold. The threshold may be a minimum number of vehicle occupants present in the vehicle for allowance in the HOV lane and the threshold number may vary according to the regional HOV rules as provided by the database. For example, the threshold may be two or three occupants, including the driver. The dashcam may utilize the cabin camera sensor in conjunction with the CMS algorithms to detect faces of the occupants as well as information regarding seat weight and seat belt latching, as provided by the OBD system, to determine the quantity of occupants in the vehicle.

If the number of occupants does not reach the threshold, the routine proceeds to 718 to present a second output outcome by activating the HOV alert. The HOV alert may include a message/notification displayed at the dashcam or announced through a speaker of the dashcam. In some examples, the alert may also be displayed/announced at the mobile device and/or dashboard user interface. The alert may include an instruction to move the vehicle out of the HOV lane at a suitable moment, e.g., a break in traffic in an adjacent lane. Alternatively, if the number of occupants at least reaches the threshold, the method continues to 720 to dampen the HOV alert. The routine ends.

In some examples, the ADAS may be further adapted to determine if a toll is required for using the HOV, based on GPS data provided by the dashcam. The ADAS may command activation of an additional alert providing information about the toll. In this way, a likelihood that a driver is using the HOV lane under invalid conditions is reduced and the driver may be notified of HOV tolls.

In a third example of an OBD-enhanced ADAS application in a vehicle, the OBD data may be used to supplement dashcam information to provide a headlight warning both during vehicle operation and when the vehicle is parked. An ADAS dashcam, such as the dashcam 128 of FIGS. 1-2 and 3A-3B, may include a front camera sensor adapted with an ambient lighting sensor to detect an intensity of ambient light and a GPS. The dashcam may further include an IMU which may be a 6-axis IMU adapted with an accelerometer such as a G-sensor.

The ADAS may use ambient lighting data and/or vehicle acceleration or movement based on signals from the front camera sensor, the GPS, and the IMU to determine the if vehicle is in motion or stationary. OBD data may be used to determine a status of the vehicle ignition to evaluate if current vehicle conditions are conducive to the headlamps being on or off. For example, the ADAS may detect that the vehicle is in motion, ambient light has decreased, and the ignition is on. By querying the OBD data, as provided through a dongle, the ADAS may confirm that the headlamps are off. An alert may be provided to a driver to turn the headlamps on.

As another example, the ADAS may determine that the vehicle is stationary based on dashcam signals. By querying the OBD data, the ADAS may also confirm that the ignition is off and the headlamps are on. An alert may be provided to the driver to turn the headlamps off.

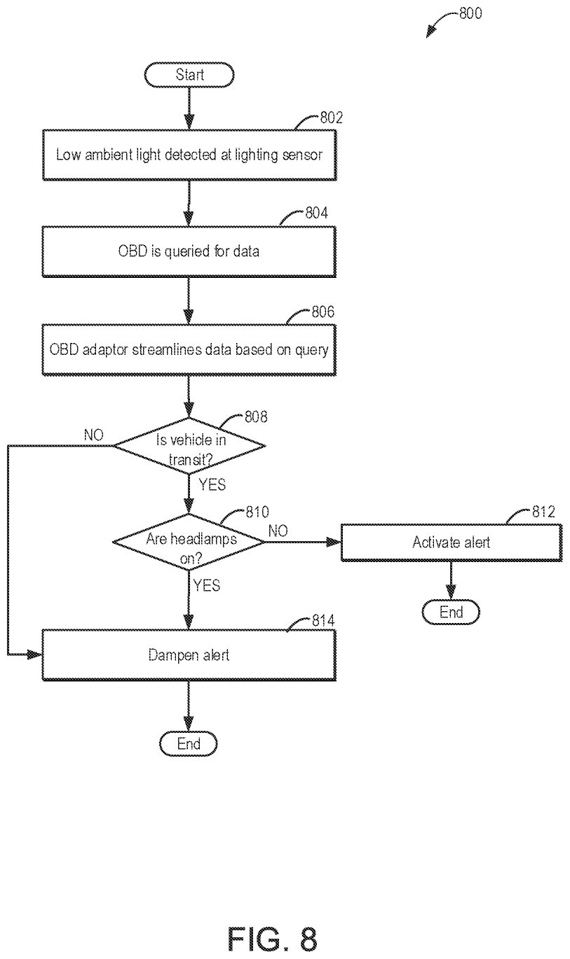

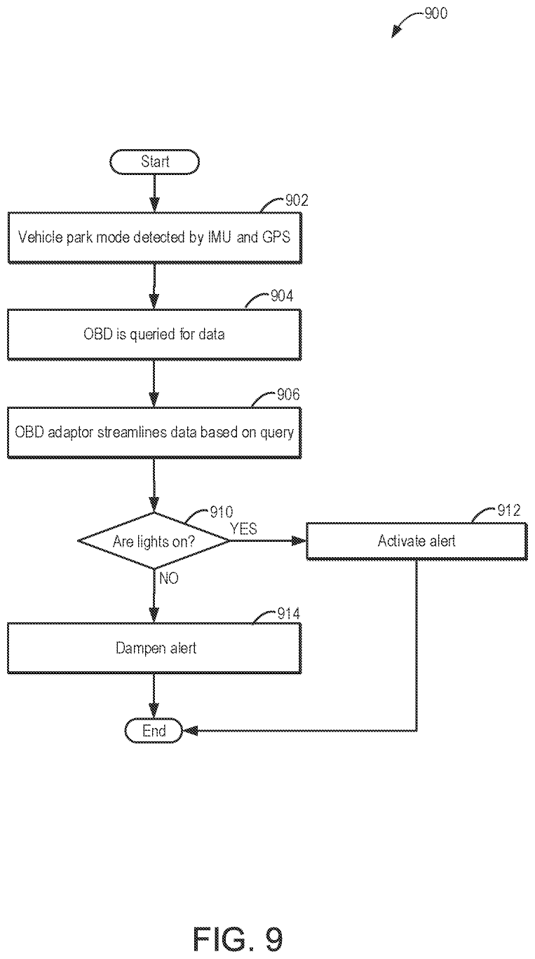

A first routine 800 and a second routine 900 for enhancing a headlamp alert system of an ADAS dashcam with OBD data are shown in FIGS. 8 and 9. Routines 800 and 900 may be implemented in a vehicle such as vehicle 102 of FIGS. 1-2 and vehicle 600 of FIG. 6, the vehicle including a dashcam such as the dashcam 128 of FIGS. 1-3B and 6. The vehicle further includes an OBD adaptor or dongle, such as the dongle 203 of FIG. 2. A processor OS of the dashcam, such as the processor OS 210 of FIG. 2 receives signals from the OBD system and from the various sensors of the dashcam and provides alerts and notifications at the dashcam based on the received signals and instructions stored on a memory of the processor.

Turning to the first routine 800 of FIG. 8, at 802, the routine includes detecting a decrease in ambient light intensity. For example, a darkening of lighting exterior to the vehicle is detected by a lighting sensor of a front camera of the dashcam. The ambient light intensity may decrease by a threshold amount, which prompts the ADAS to query the dongle at 804.

Querying the dongle may include sending a request for OBD data relevant to detection of the change in ambient lighting. As an example, upon receiving the request, an MCU of the dongle may determine which data is relevant and streamline the data relayed to the ADAS by whitelisting the data at 806. As such, a signal from a headlamp sensor of the vehicle may be extracted from the OBD data and sent to the dashcam and used in combination with information from the dashcam sensors to modify an output of the ADAS.

The routine includes determining if the vehicle is in transit at 808. For example, the ADAS may query the OBD data, to request information regarding a status of an ignition of the vehicle (e.g., off or on) based on a signal from an ignition sensor. The routine may also supplement the ignition status signal with information from an IMU and a GPS to further confirm if the vehicle is in motion. For example, a G-sensor of the IMU and changes in the vehicle location according to GPS tracking may verify if the vehicle is currently being driven.

If the vehicle is not in transit, the routine continues to 814 to present a first output outcome of the ADAS by dampening a headlamp alert, e.g., the alert is not displayed or announced. If the vehicle is confirmed to be in motion, the routine proceeds to 810 to determine if the headlamps are on based on the OBD data. If the headlamps are not on, a second output outcome of the ADAS is presented at 812 by activating a headlamp alert to notify an operator that the headlamps are off and should be turned on. The headlamp alert may be displayed as described above, e.g., at a display of the dashcam or announced through a speaker of the dashcam. Additionally, the headlamp alert may be displayed/announced at a mobile device and/or a dashboard user interface.

If the headlamps are confirmed to be on, the routine proceeds to 814 to dampen the headlamp alert and the routine ends. In this way, by combining statuses of the ignition and headlamps, as detected by the OBD system, with data from the dashcam sensors, a likelihood that the vehicle is driven in darkening conditions without the headlamps on is reduced.

In the second routine 900 of FIG. 9, the routine includes detecting that the vehicle is in a parked mode at 902. Detecting the parked mode includes verifying that the vehicle is stationary via the IMU and GPS of the dashcam. Upon detection of the vehicle entering the parked mode, the ADAS queries the dongle at 904. Querying the dongle may include sending a request for information relevant to the parked status of the vehicle. For example, the relevant information may include a transmission state of the vehicle and the ignition status to confirm that the vehicle is parked as well as statuses of the vehicle lights, including the headlamps, interior lights, fog lights, etc.

The MCU of the dongle streamlines the OBD data at 906, e.g., by whitelisting, to send the relevant data to the ADAS. The ADAS uses the streamlined OBD data to determine if the vehicle headlamps and/or any other lights are on at 910. If any of the lights are confirmed to be on based on the data from the OBD, the routine continues to 912 to provide a first output outcome of the ADAS by activating an alert to notify the operator that the vehicle lights are on and should be turned off. The alert may be displayed/announced as described above. If the lights are not on, the routine proceeds to 914 to present a second output outcome of the ADAS by dampening the alert. The routine ends.

By combining the OBD data with signals from the dashcam sensors, continued illumination of vehicle lights after the vehicle is parked and the ignition turned off is minimized. A likelihood of the lights causing a vehicle battery to be drained of charge is thereby decreased.

In a fourth example of an OBD-enhanced ADAS application in a vehicle, the OBD data may be used to supplement dashcam information to provide a wheel angle warning when the vehicle is parked. For example, in some regions, wheels of the vehicle are required to be angled in a certain direction when parked on an incline. Non-compliance with parking rules may lead to citations. In order to reduce a likelihood that an parked vehicle is non-compliant with parking rules specific to a region, the ADAS may be configured with a database including parking laws of various regions, the database stored at a server, such as the cloud server node 212 of FIG. 2. However, other modes of storage and access are possible. By combining vehicle information such as a transmission mode, an ignition status, and front wheel angle relayed from the OBD system, with data obtained from dashcam sensors such as a GPS and an IMU, the operator may be notified when the vehicle front wheels are not adjusted according to regional rules with respect to parking on a slope.

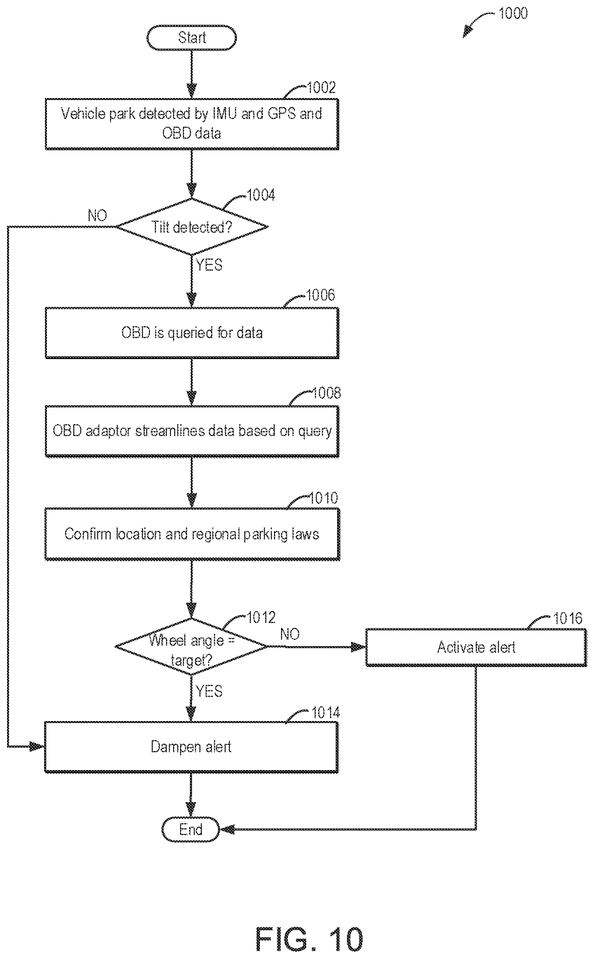

A routine 1000 for enhancing a wheel angle alert system of an ADAS dashcam with OBD data is shown in FIG. 10. Routine 1000 may be implemented in a vehicle such as vehicle 102 of FIGS. 1-2 and vehicle 600 of FIG. 6, the vehicle including a dashcam such as the dashcam 128 of FIGS. 1-3B and 6. The vehicle further includes an OBD adaptor or dongle, such as the dongle 203 of FIG. 2. A processor OS of the dashcam, such as the processor OS 210 of FIG. 2 receives signals from the OBD system and from the various sensors of the dashcam and provides alerts and notifications at the dashcam based on the received signals and instructions stored on a memory of the processor.

At 1002, the routine includes detecting that a vehicle status is adjusted to a parking mode. The ADAS may determine that the vehicle is parked based on signals from an IMU and a GPS of the dashcam as described above with reference to FIG. 9. The ADAS may further confirm that the vehicle is parked by querying the OBD data to obtain information from a transmission mode and an ignition status of the vehicle, as described above with reference to FIG. 9.

The routine proceeds to 1004 to determine if a tilt is detected at the vehicle. The vehicle may be tilted if parked on a slope and the tilt may be detected by a G-sensor of the IMU of the dashcam. The G-sensor may utilize a gyroscope to determine if the vehicle is angled relative to a reference plane, e.g., a horizontal plane, and the vehicle may be deemed tilted when an angle of the vehicle, relative to the reference plane is greater than a threshold amount. For example, the vehicle may be tilted when the angle of the vehicle, relative to the horizontal plane, is 10 degrees or greater, or some other threshold angle.

If the vehicle is not tilted, the routine continues to 1014 to provide a first output outcome by dampening a wheel angle alert, as described further below. If the vehicle is tilted, the routine proceeds to 1006 to query the dongle, requesting information relevant to the detection of vehicle tilt. The relevant data may include a signal from a wheel angle sensor of the vehicle, for example. Upon receiving the request, an MCU of the dongle may streamline the data at 1008 to extract the wheel angle sensor data and relay the extracted data to the ADAS.

At 1010, the routine includes requesting information from a database stored on a server, such as the cloud server node 212 of FIG. 2, to determine parking laws specific to a location of the vehicle. The location of the vehicle may be confirmed by GPS and used to search the database for the corresponding parking laws. By referring to regional parking laws, rules and regulations regarding wheel positioning when parking on a slope may be verified.

At 1012, the routine includes verifying if the front wheels are angled, e.g., turned to the left or the right, relative to a central axis extending along a length of the vehicle, based on the OBD data. The detected position of the front wheels is compared to a target direction which is determined based on the verified regional parking laws. If the front wheel angle is turned according to the target direction, the routine proceeds to 1014 to dampening the wheel angle alert. Dampening the alert includes not displaying and/or announcing the alert at the dashcam, a mobile device, or a dashboard user interface of the vehicle. If the front wheel angle does not match the target direction, e.g., the front wheels are not turned or turned in an opposite direction, a second output outcome of the ADAS is presented at 1016 by activating the wheel angle alert. Activating the alert includes displaying the alert visually or sounding an audio notification at the dashcam. The alert may also be displayed/announced at the mobile device and/or the dashboard user interface of the vehicle. In some examples, the alert may be activated depending on whether the tires angled within a threshold range of angles in the target direction. For example, if the tires are not angled in the target direction by at least 30 degrees, the alert may be activated. The routine ends.

In this way, an output of a vehicle ADAS may be modified and enhanced by supplementing information provided by an ADAS device, such as a dashcam, with signals obtained from vehicle sensors and systems. By pairing an OBD adaptor or dongle with the dashcam, e.g., communicatively linking the devices, the ADAS may respond more accurately to a current state of the vehicle and current driving/operating conditions. The ADAS may be configured to query the dongle via a PID connection and streamline the data using whitelisting to continuously update the ADAS with relevant data from the vehicle sensors. As a result, the ADAS may provide more useful and appropriate notifications. The pairing of the ADAS with OBD data may also allow the ADAS to generate new alerts in addition to those available based exclusively on the dashcam sensors. Furthermore, the enhancement of the ADAS may be achieved without adding vehicle components or increasing a computing burden of the ADAS. A technical effect of supplementing the ADAS with OBD data is that an accuracy of the ADAS's ability to assess driving conditions is increased, thereby minimizing driver errors during vehicle operation.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as the ADAS dashcam 128 of FIGS. 1-3B and/or OBD dongle 203 of FIG. 2. The methods may be performed by executing stored instructions with one or more logic devices (e.g., processors) in combination with one or more additional hardware elements, such as storage devices, memory, hardware network interfaces/antennas, switches, actuators, clock circuits, etc. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

The disclosure also provides support for an advanced driver-assistance system (ADAS) for a vehicle, the aDaS comprising: an onboard diagnostics (OBD) adaptor configured to obtain information from vehicle sensors, and an in-vehicle device communicatively linked to the OBD adaptor and configured to monitor driving conditions and provide an alert to an operator, the in-vehicle device including a processor with computer readable instructions stored in non-transitory memory that, when executed, cause the processor to: receive a first set of data from the OBD adaptor, receive a second set of data from sensors of the in-vehicle device, and generate an output based on both the first set of data and the second set of data, wherein the output includes one of activation or dampening of the alert, the alert indicating a change in the monitored driving conditions. In a first example of the system, the OBD adaptor is plugged into a port in a cabin of the vehicle to connect the OBD adaptor to the in-vehicle device through a proportional-integral-derivative (PID) connection and wherein the OBD adaptor is configured to receive the information from the vehicle sensors through a controller area network (CAN). In a second example of the system, optionally including the first example, the activation of the alert is presenting at least one of a visual alert and an audio alert at one or more of the in-vehicle device, a vehicle user interface, and a mobile device. In a third example of the system, optionally including the first and second examples, the dampening of the alert includes at least one of reducing, suppressing and muting at least one of the visual alert and the audio alert. In a fourth example of the system, optionally including the first through third examples, the in-vehicle device is a dashboard camera (dashcam) and wherein the sensors of the dashcam include one or more of a front camera, a cabin camera, a lighting sensor, a GPS, and an inertial measurement unit (IMU). In a fifth example of the system, optionally including the first through fourth examples, the processor includes additional computer readable instructions stored in non-transitory memory that, when executed, cause the processor to: retrieve information from one or more databases stored at a cloud-based server, the server accessible via a long-term evolution (LTE) connection, wherein the one or more databases provides information regarding at least one of the vehicle and a region in which the vehicle is located. In a sixth example of the system, optionally including the first through fifth examples, the information from the one or more databases is used in conjunction with the first set of data and the second set of data to generate the output. In a seventh example of the system, optionally including the first through sixth examples, a mobile device is communicatively coupled to the in-vehicle device through the LTE connection. In an eighth example of the system, optionally including the first through seventh examples, the OBD adaptor includes a microcontroller unit (MCU) configured to streamline the first set of data prior to sending the first set of data and wherein the first set of data is streamlined to extract information relevant to the second set of data.

The disclosure also provides support for a method for an advanced driver-assistance system (ADAS) of a vehicle, the method comprising: responsive to a change in driving conditions detected at sensors of an in-vehicle device: obtaining a first set of data from the sensors of the in-vehicle device, the first set of data collected based on the change in driving conditions, querying an onboard diagnostics (OBD) system of the vehicle by sending a request for vehicle information from the in-vehicle device to the OBD system, the vehicle information collected by the OBD system and extracted based on the first set of data to generate a second set of data, receiving the second set of data from the OBD system, and generating an output based on a combination of the first set of data and the second set of data, the output including presenting an alert to a driver at least at the in-vehicle device. In a first example of the method, the change detected at the sensors of the in-vehicle device includes one or more of an appearance of an object in a field of view of a front camera sensor, a change in motion of the vehicle detected by an inertial measurement unit (IMU), a change in a position of a driver's head detected by a cabin camera sensor, and a change in ambient light detected by a lighting sensor. In a second example of the method, optionally including the first example, extracting the vehicle information includes whitelisting the vehicle information to extract information relevant to the first set of data and sending the extracted information to a processor of the in-vehicle device. In a third example of the method, optionally including the first and second examples, querying the OBD system includes sending the request for the vehicle information from the in-vehicle device to an OBD adaptor communicatively coupled to a controller area network (CAN), the CAN configured to receive signals from the sensors of the vehicle, and wherein the request is sent via a proportional-integral-derivative (PID) connection between the OBD adaptor and the in-vehicle device. In a fourth example of the method, optionally including the first through third examples, generating the output includes one of providing an alert at the in-vehicle device and suppressing the alert at the in-vehicle device. In a fifth example of the method, optionally including the first through fourth examples, generating the output includes determining if a driver is to be notified of a lane departure when the first set of data is obtained from the front camera sensor and the second set of data is obtained from a turn indicator sensor and wherein a region of interest of the front camera sensor is adjusted based on the second set of data. In a sixth example of the method, optionally including the first through fifth examples, generating the output includes determining if a driver is to be notified of distracted driving when the first set of data is obtained from the cabin camera sensor and the second set of data is obtained from a turn indicator sensor. In a seventh example of the method, optionally including the first through sixth examples, generating the output includes determining if a driver is to be notified of a high occupancy vehicle (HOV) lane non-compliance when the first set of data is obtained from the front camera sensor and the second set of data is obtained from a first database providing vehicle information based on a vehicle identification number of the vehicle and wherein determining if the driver is to be notified further includes using data obtained from the cabin camera and data obtained from a second database storing regional HOV lane rules. In an eighth example of the method, optionally including the first through seventh examples, generating the output includes determining if a reminder to turn on vehicle headlamps is to be presented to a driver when the first set of data is obtained from the lighting sensor and the second set of data is obtained from a headlamp sensor and wherein the reminder is further based on information provided by the IMU and a GPS of the in-vehicle device. In a ninth example of the method, optionally including the first through eighth examples, generating the output includes determining if the reminder to turn off the vehicle headlamps is to be presented to the driver when the first set of data is obtained from the GPS and the IMU and the second set of data is obtained from the headlamp sensor. In a tenth example of the method, optionally including the first through ninth examples, generating the output includes determining if a wheel angle alert is to be presented to a driver when the first set of data is obtained from the IMU and the second set of data is obtained from a wheel angle sensor and wherein the wheel angle alert is further based on information from a database providing regional parking laws.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The following claims particularly point out subject matter from the above disclosure that is regarded as novel and non-obvious.

1. An advanced driver-assistance system (ADAS) for a vehicle, the ADAS comprising:
an onboard diagnostics (OBD) adaptor configured to obtain information from vehicle sensors; and
an in-vehicle device communicatively linked to the OBD adaptor and configured to monitor driving conditions and provide an alert to an operator, the in-vehicle device including a processor with computer readable instructions stored in non-transitory memory that, when executed, cause the processor to:
receive a first set of data from the OBD adaptor;
receive a second set of data from sensors of the in-vehicle device; and
generate an output based on both the first set of data and the second set of data, wherein the output includes one of activation or dampening of the alert, the alert indicating a change in the monitored driving conditions.

2. The ADAS of claim 1, wherein the OBD adaptor is plugged into a port in a cabin of the vehicle to connect the OBD adaptor to the in-vehicle device through a proportional-integral-derivative (PID) connection and wherein the OBD adaptor is configured to receive the information from the vehicle sensors through a controller area network (CAN).

3. The ADAS of claim 1, wherein the activation of the alert is presenting at least one of a visual alert and an audio alert at one or more of the in-vehicle device, a vehicle user interface, and a mobile device.

4. The ADAS of claim 3, wherein the dampening of the alert includes at least one of reducing, suppressing and muting at least one of the visual alert and the audio alert.

5. The ADAS of claim 1, wherein the in-vehicle device is a dashboard camera (dashcam) and wherein the sensors of the dashcam include one or more of a front camera, a cabin camera, a lighting sensor, a GPS, and an inertial measurement unit (IMU).

6. The ADAS of claim 1, wherein the processor includes additional computer readable instructions stored in non-transitory memory that, when executed, cause the processor to:
retrieve information from one or more databases stored at a cloud-based server, the server accessible via a long-term evolution (LTE) connection, wherein the one or more databases provides information regarding at least one of the vehicle and a region in which the vehicle is located.

7. The ADAS of claim 6, wherein the information from the one or more databases is used in conjunction with the first set of data and the second set of data to generate the output.

8. The ADAS of claim 6, wherein a mobile device is communicatively coupled to the in-vehicle device through the LTE connection.

9. The ADAS of claim 1, wherein the OBD adaptor includes a microcontroller unit (MCU) configured to streamline the first set of data prior to sending the first set of data and wherein the first set of data is streamlined to extract information relevant to the second set of data.

10. A method for an advanced driver-assistance system (ADAS) of a vehicle, the method comprising:
responsive to a change in driving conditions detected at sensors of an in-vehicle device:
obtaining a first set of data from the sensors of the in-vehicle device, the first set of data collected based on the change in driving conditions;
querying an onboard diagnostics (OBD) system of the vehicle by sending a request for vehicle information from the in-vehicle device to the OBD system, the vehicle information collected by the OBD system and extracted based on the first set of data to generate a second set of data;
receiving the second set of data from the OBD system; and
generating an output based on a combination of the first set of data and the second set of data, the output including presenting an alert to a driver at least at the in-vehicle device.

11. The method of claim 10, wherein the change detected at the sensors of the in-vehicle device includes one or more of an appearance of an object in a field of view of a front camera sensor, a change in motion of the vehicle detected by an inertial measurement unit (IMU), a change in a position of a driver's head detected by a cabin camera sensor, and a change in ambient light detected by a lighting sensor.

12. The method of claim 10, wherein extracting the vehicle information includes whitelisting the vehicle information to extract information relevant to the first set of data and sending the extracted information to a processor of the in-vehicle device.

13. The method of claim 10, wherein querying the OBD system includes sending the request for the vehicle information from the in-vehicle device to an OBD adaptor communicatively coupled to a controller area network (CAN), the CAN configured to receive signals from the sensors of the vehicle, and wherein the request is sent via a proportional-integral-derivative (PID) connection between the OBD adaptor and the in-vehicle device.

14. The method of claim 10, wherein generating the output includes one of providing an alert at the in-vehicle device and suppressing the alert at the in-vehicle device.

15. The method of claim 10, wherein generating the output includes determining if a driver is to be notified of a lane departure when the first set of data is obtained from the front camera sensor and the second set of data is obtained from a turn indicator sensor and wherein a region of interest of the front camera sensor is adjusted based on the second set of data.

16. The method of claim 10, wherein generating the output includes determining if a driver is to be notified of distracted driving when the first set of data is obtained from the cabin camera sensor and the second set of data is obtained from a turn indicator sensor.

17. The method of claim 10, wherein generating the output includes determining if a driver is to be notified of a high occupancy vehicle (HOV) lane non-compliance when the first set of data is obtained from the front camera sensor and the second set of data is obtained from a first database providing vehicle information based on a vehicle identification number of the vehicle and wherein determining if the driver is to be notified further includes using data obtained from the cabin camera and data obtained from a second database storing regional HOV lane rules.

18. The method of claim 10, wherein generating the output includes determining if a reminder to turn on vehicle headlamps is to be presented to a driver when the first set of data is obtained from the lighting sensor and the second set of data is obtained from a headlamp sensor and wherein the reminder is further based on information provided by the IMU and a GPS of the in-vehicle device.

19. The method of claim 18, wherein generating the output includes determining if the reminder to turn off the vehicle headlamps is to be presented to the driver when the first set of data is obtained from the GPS and the IMU and the second set of data is obtained from the headlamp sensor.

20. The method of claim 10, wherein generating the output includes determining if a wheel angle alert is to be presented to a driver when the first set of data is obtained from the IMU and the second set of data is obtained from a wheel angle sensor and wherein the wheel angle alert is further based on information from a database providing regional parking laws.
